(19) United States
(12) Patent Application Publication
(10) Pub. No.: US 2026/0269982 A1
(43) Pub. Date: Sep. 10, 2026

(54) INTERLEAVING METHOD AND COMMUNICATION APPARATUS

(71) Applicant: HUAWEI TECHNOLOGIES CO., LTD., Shenzhen (CN)

(72) Inventors: Jiajie Tong, Hangzhou (CN); Ke Liu, Hangzhou (CN); Huazi Zhang, Hangzhou (CN); Yinggang Du, Shenzhen (CN); Kangjian Qin, Hangzhou (CN); Xianbin Wang, Hangzhou (CN); Jun Wang, Hangzhou (CN)

(21) Appl. No.: 19/665,065

(22) Filed: May 1, 2026

Related U.S. Application Data
(63) Continuation of application No. PCT/CN2024/114528, filed on Aug. 26, 2024.

(30) Foreign Application Priority Data
Nov. 6, 2023 (CN) 202311473481.3

(51) Int. Cl. H04L 1/00

(52) U.S. Cl. CPC H04L 1/0071; H04L 1/0045

(57) ABSTRACT

According to an interleaving method and a communication apparatus that are used in channel coding, bits in a to-be-interleaved first bit sequence are divided into X groups based on a quantity R of energy levels included in a modulation symbol, where X is less than or equal to R, and then bit interleaving and modulation are performed on the first bit sequence based on the X groups. Qₘ bits included in each modulation symbol are from the X groups of the first bit sequence, at least two bits in the Qₘ bits are from a same group among the X groups, and a relative position between the at least two bits in the second bit sequence after the interleaving remains unchanged from that in the first bit sequence before the interleaving.

### CROSS-REFERENCE TO RELATED APPLICATIONS

This application is a continuation of International Application No. PCT/CN2024/114528, filed on Aug. 26, 2024, which claims priority to Chinese Patent Application No. 202311473481.3, filed on Nov. 6, 2023. The disclosures of the aforementioned applications are hereby incorporated by reference in their entireties.

### TECHNICAL FIELD

This application relates to the channel coding field, and more specifically, to an interleaving method and a related communication apparatus in channel coding.

### BACKGROUND

Low-density parity-check (LDPC) codes are a channel coding scheme that operates very close to the Shannon limit, offering excellent performance with low complexity. LDPC has been adopted by the 3rd generation partnership project (3GPP) as a data channel coding scheme in 5th generation (5G) mobile networks.

To improve decoding performance, LDPC currently generally employs row-column bit interleaving, in which LDPC systematic bits are mapped onto high-energy-level bits of quadrature amplitude modulation (QAM), to protect the LDPC systematic bits. The use of row-column interleaving can ensure correctness of information bits even if final LDPC decoding fails to achieve full accuracy of all encoded bits. However, hardware implementation of the row-column interleaving is complex. In high throughput scenarios, this severely affects an overall decoding rate and becomes a bottleneck for a system decoding throughput.

### SUMMARY

This application provides an interleaving method and a communication apparatus, to reduce hardware complexity of interleaving while ensuring interleaving performance.

According to a first aspect, an interleaving method is provided. The method includes: obtaining a to-be-interleaved first bit sequence, where the first bit sequence includes X groups, X is less than or equal to R, R is a quantity of energy levels included in one modulation symbol, and both X and R are positive integers; performing bit interleaving on the first bit sequence to obtain a second bit sequence; mapping bits in the second bit sequence to a quadrature amplitude modulation (QAM) symbol, where each QAM symbol includes Qₘ bits, the Qₘ bits are from the X groups, at least two bits in the Qₘ bits are from a same group among the X groups, and a relative position between the at least two bits in the second bit sequence remains unchanged from that in the first bit sequence; and outputting a modulated QAM symbol.

In technical solutions of this application, bits in the to-be-interleaved first bit sequence are divided into the X groups based on the quantity R of energy levels included in the modulation symbol, then the bit interleaving is performed on the first bit sequence based on the X groups, and the interleaved second bit sequence is mapped to the QAM symbol. Qₘ bits included in each modulation symbol are from the X groups of the first bit sequence, at least two bits in the Qₘ bits are from a same group among the X groups, and a relative position between the at least two bits in the second bit sequence after the interleaving remains unchanged from that in the first bit sequence before the interleaving. This can reduce hardware complexity of the interleaving while ensuring interleaving performance.

In some implementations of the first aspect, that the at least two bits in the Qₘ bits are from the same group among the X groups includes: Two bits in the Qₘ bits are from a same group among the X groups, and the two bits correspond to two bit positions of a same energy level in the QAM symbol.

In the implementation, a change to an existing row-column interleaving scheme is small, and the scheme is easy to be improved. In comparison with row-column interleaving, complexity of an improved interleaving scheme may be reduced by half. For example, a system quantization bit width (hereinafter referred to as a systematic bit width for short) is reduced by half.

In some implementations of the first aspect, X=2, and that the at least two bits in the Qₘ bits are from the same group among the X groups includes: Two bits in the Qₘ bits are from a first group among the X groups, remaining Qₘ−2 bits in the Qₘ bits are from a second group among the X groups, and the two bits in the first group correspond to two bit positions of a lowest energy level in the QAM symbol.

In the implementation, interleaving complexity can be greatly reduced, and interleaving performance basically remains unchanged.

In some implementations of the first aspect, X=2, and that the at least two bits in the Qₘ bits are from the same group among the X groups includes: A bits in the Qₘ bits are from a first group among the X groups, remaining Qₘ−A bits in the Qₘ bits are from a second group among the X groups, and the A bits in the first group correspond to first A bit positions in ascending order of energy in the QAM symbol.

In this implementation, interleaving complexity can be reduced, and the interleaving performance is more stable.

In some implementations of the first aspect, before the performing interleaving on the first bit sequence to obtain the second bit sequence, the method further includes: determining A; and the performing interleaving on the first bit sequence to obtain the second bit sequence includes: when A is greater than or equal to 1, performing bit interleaving on the first bit sequence to obtain the second bit sequence.

According to a second aspect, a deinterleaving method is provided. The method includes: obtaining a to-be-demodulated QAM symbol; performing demodulation on the QAM symbol to obtain a first information sequence; performing deinterleaving on the first information sequence to obtain a second information sequence, where LLR information in the second information sequence includes X groups, each QAM symbol includes Qₘ pieces of LLR information, the Qₘ pieces of LLR information are from the X groups of the second information sequence, at least two pieces of LLR information in the Qₘ pieces of LLR information are from a same group among the X groups, a relative position between the at least two pieces of LLR information in the second information sequence remains unchanged from that in the first information sequence, X is less than or equal to R, R is a quantity of energy levels included in one modulation symbol, and both X and R are positive integers; and outputting the second information sequence.

For beneficial technical effects of the method in the second aspect, refer to descriptions of the first aspect.

In some implementations of the second aspect, that the at least two pieces of LLR information in the Qₘ pieces of LLR information are from the same group among the X groups includes: Two pieces of LLR information in the Qₘ pieces of LLR information are from a same group among the X groups, and the two pieces of LLR information correspond to two bit positions of a same energy level in the QAM symbol.

In the implementation of the second aspect, a person skilled in the art should understand that bits (which may include systematic bits and parity bits) sent by an encoding device are represented as LLR information at a decoding device. The Qₘ pieces of LLR information may correspond to Qₘ bit positions included in the QAM symbol, and each piece of LLR information represents a probability that a bit at a corresponding bit position is 0 or 1. The descriptions are also applicable to another implementation of the second aspect.

In some implementations of the second aspect, X=2, and that the at least two pieces of LLR information in the Qₘ pieces of LLR information are from the same group among the X groups includes: Two pieces of LLR information in the Qₘ pieces of LLR information are from a first group among the X groups, remaining Qₘ−2 pieces of LLR information in the Qₘ pieces of LLR information are from a second group among the X groups, and the two pieces of LLR information in the first group correspond to two bit positions of a lowest energy level in the QAM symbol.

In some implementations of the second aspect, X=2, and that the at least two pieces of LLR information in the Qₘ pieces of LLR information are from the same group among the X groups includes: A pieces of LLR information in the Qₘ pieces of LLR information are from a first group among the X groups, remaining Qₘ−A pieces of LLR information in the Qₘ pieces of LLR information are from a second group among the X groups, and the A pieces of LLR information in the first group correspond to first A bit positions in ascending order of energy in the QAM symbol.

In some implementations of the second aspect, before the performing deinterleaving on the first information sequence to obtain the second information sequence, the method further includes: determining A; and the performing deinterleaving on the first information sequence to obtain the second information sequence includes: when A is greater than or equal to 1, performing deinterleaving on the first information sequence to obtain the second information sequence.

In some implementations of the first aspect or the second aspect, A is determined based on a code rate.

In the implementation, a value of A may be first calculated, and bit interleaving is performed when the value of A is greater than or equal to 1. Interleaving or non-interleaving may be flexibly selected based on different sending parameters (for example, a code rate, or a sending ratio of a core matrix and an extension matrix), so that both interleaving complexity and interleaving requirements in different sending scenarios can be considered.

In an example, A is determined according to the following formula: A=round((1−code rate)×Qₘ), where round represents a round function.

In some implementations of the first aspect or the second aspect, A is determined based on a sending ratio of a core matrix and an extension matrix.

In an example, A is determined according to the following formula:

A=round(quantity of columns of the extension matrix/(quantity of to-be-sent columns of the core matrix+quantity of to-be-sent columns of the extension matrix)×Qₘ),

where round represents a round function.

According to a third aspect, a communication apparatus is provided. The communication apparatus has a function of implementing the method in the first aspect or the second aspect, or the method in any possible implementation of the first aspect or the second aspect. The function may be implemented by hardware, or may be implemented by hardware executing corresponding software. The hardware or the software includes one or more units corresponding to the foregoing function.

According to a fourth aspect, this application provides a communication apparatus, including at least one processor. The at least one processor is coupled to at least one memory. The at least one memory is configured to store a computer program or instructions. The at least one processor is configured to invoke the computer program or the instructions from the at least one memory and run the computer program or the instructions, so that the communication apparatus performs the method in the first aspect or any possible implementation of the first aspect, or performs the method in the second aspect or any possible implementation of the second aspect.

In an example, the communication apparatus according to the third aspect or the fourth aspect may be an encoding apparatus or a decoding apparatus.

According to a fifth aspect, this application provides a communication apparatus, including a communication interface and a circuit. The communication interface is configured to: receive a to-be-interleaved first bit sequence, and input the first bit sequence to the circuit. The circuit performs bit interleaving on the first bit sequence based on the interleaving method provided in this application, and maps a second bit sequence obtained through bit interleaving to a QAM symbol. The communication interface is further configured to output a modulated QAM symbol. For example, the communication apparatus in the fifth aspect is an encoding apparatus.

According to a sixth aspect, a communication apparatus is provided, and includes a communication interface and a circuit. The communication interface is configured to: receive a to-be-demodulated QAM symbol, and input the QAM symbol to the circuit. The circuit performs demodulation on the QAM symbol according to the deinterleaving method provided in this application, to obtain a first information sequence, and performs deinterleaving on the first information sequence to obtain a second information sequence. The communication interface is further configured to output the second information sequence. Further, the circuit may be further configured to determine an information bit based on the second information sequence, and the communication interface is further configured to output the information bit. For example, the communication apparatus in the sixth aspect is a decoding apparatus.

According to a seventh aspect, this application provides a computer-readable storage medium. The computer-readable storage medium stores computer instructions, and when the computer instructions are run on a computer, the method in the first aspect or any possible implementation of the first aspect is implemented, or the method in the second aspect or any possible implementation of the second aspect is implemented.

According to an eighth aspect, this application provides a computer program product. The computer program product includes computer program code, and when the computer program code is run on a computer, the method in the first aspect or any possible implementation of the first aspect is implemented, or the method in the second aspect or any possible implementation of the second aspect is implemented.

According to a ninth aspect, this application provides a wireless communication system, including the communication apparatus according to any one of the third aspect to the sixth aspect, for example, an encoding apparatus and/or a decoding apparatus.

### BRIEF DESCRIPTION OF DRAWINGS

FIG. 1 is an example of LDPC systematic bit protection;

FIG. 2 is a diagram of reading and writing of row-column interleaving;

FIG. 3 is a diagram of implementing row-column interleaving through memory concatenation;

FIG. 4 is a diagram of a system architecture applicable to embodiments of this application;

FIG. 5 is a schematic flowchart of an interleaving method and a deinterleaving method according to this application;

FIG. 6 is a diagram of an interleaving process in Example 1 according to this application;

FIG. 7 is a diagram of an interleaving process in Example 2 according to this application;

FIG. 8 is a diagram of an interleaving process in Example 3 according to this application;

FIG. 9 is a simulation comparison diagram of performance of a bit interleaving method and performance of a row-column interleaving method according to this application;

FIG. 10 is a diagram of a structure of a communication apparatus according to this application;

FIG. 11 is a diagram of a structure of another communication apparatus according to this application; and

FIG. 12 is a diagram of a structure of still another communication apparatus according to this application.

### DESCRIPTION OF EMBODIMENTS

The following describes technical solutions in this application with reference to the accompanying drawings.

For ease of understanding the technical solutions provided in this application, related technologies or concepts in embodiments of this application are briefly described.

Quasi-cyclic low-density parity-check codes (QC-LDPC) are a type of structured LDPC codes. A parity matrix of the quasi-cyclic low-density parity-check codes may be decomposed into a z×z all-zero matrix and a circulant permutation matrix. The circulant permutation matrix is obtained by cyclically right-shifting a z×z identity matrix. A matrix before extension is referred to as a base matrix, and a Tanner graph corresponding to the base matrix is referred to as a base graph (BG). Fifth-generation (5G) LDPC defines two base graphs: BG1 and BG2. Selection of the BG1 and the BG2 is based on a transport block (TB) and a target code rate of 1^{st} transmission. For a given lifting size z, a parity matrix may be obtained through extension.

Quadrature amplitude modulation (QAM) is a type of high order modulation. One QAM symbol may carry information of a plurality of bits. For example, one symbol of 64QAM carries information of six bits. One symbol of 128QAM carries information of eight bits. A higher QAM modulation order indicates a larger quantity of bits that can be transmitted in one symbol. In high order modulation, bits carried in one QAM symbol have different reliability, or have different energy. For example, one 256QAM symbol may include eight bits, where first two bits have highest energy and highest reliability, a 3rd bit and a 4th bit have second highest reliability, and a 5th bit and a 6th bit have lower reliability.

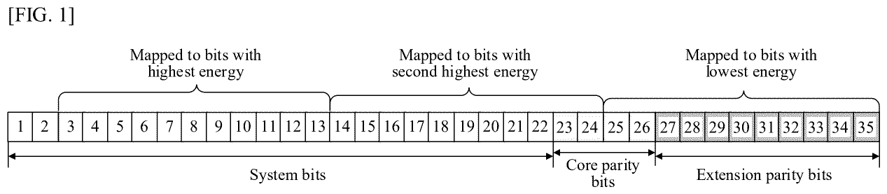

FIG. 1 is an example of LDPC systematic bit protection. An objective of the LDPC information bit protection is to map LDPC systematic bits to high-energy-level bit positions in a QAM symbol. For example, an LDPC information length is 8448, and an LDPC sending length is 12672. This constitutes an LDPC code rate of 2/3. In new radio (NR) coding protocols, BG1 coding is used, and a selected lifting size is 384. Therefore, there are 22 information columns, and each information column includes 384 bits. Puncturing first two columns is specified in the NR protocols. Therefore, a quantity of parity columns should be 12672/384−(22−2)=13, as shown in FIG. 1. There are four core parity columns and nine extension parity columns, and the 13 columns are used as LDPC parity columns. After the first two columns are punctured but not sent, 20 columns are left in the systematic bits. Together with the 13 parity columns, there are a total of 33 to-be-sent columns. Column indexes of the 33 to-be-sent columns are 3 to 35 in FIG. 1. 22 information columns/33 to-be-sent columns=2/3, which is the LDPC code rate.

In addition, it is specified in 5G that rate matching is performed after LDPC coding to obtain a sending sequence, and bit interleaving usually needs to be performed on the sending sequence. The bit interleaving is scrambling an order of bits after the rate matching, to resist burst interference. After the interleaving, original consecutive burst interference may become random single interference, which facilitates decoding. In a modulation scheme using high order modulation, effect of the interleaving is more significant.

A most commonly used interleaving manner is row-column interleaving. The row-column interleaving is rearranging an order of bits by performing writing row by row and performing reading column by column. It is assumed that a sending sequence obtained through rate matching is represented as e, and a sequence obtained through interleaving is denoted as a sequence f. If the row-column interleaving is used, a relationship between the sequence f and the sequence e may be as follows:

```
for j=0 to E/Qₘ−1
for i=0 to Qₘ−1
    f_{i+j·Q}_{ₘ} =e_{i·E/Q}_{ₘ}₊ⱼ
  end for
end for
```

E represents a sending length, Qₘ represents a quantity of bits included in each modulation symbol, j represents an index of a QAM symbol, and i represents an index of a bit position included in each QAM symbol. For a bit sequence with a sending length is E, a quantity of QAM symbols is E/Qₘ. Therefore, a value of j ranges from 0 to E/Qₘ−1. If a quantity of bits included in one QAM symbol is Qₘ, a value of i ranges from 0 to Qₘ−1.

It can be learned from the relationship between the sequence e and the sequence f that, after the bit interleaving, a position index of a bit whose position index in the sequence e is i·E/Qₘ+j is i+j·Qₘ in the sequence f.

It can be learned from the foregoing descriptions that if Qₘ=6, there are three energy levels. It can be learned from the formula of the relationship between the sending sequence e and the sequence f after the interleaving that a 3^{rd} column to a 13^{th} column of the systematic bits are mapped to a 1^{st} bit position and a 2^{nd} bit position, namely, two bit positions with highest energy, in the QAM symbol; a 14^{th} column to a 24^{th} column of the systematic bits are mapped to a 3^{rd} bit position and a 4^{th} bit position, namely, two bit positions with second highest energy, in the QAM symbol; and a 3^{rd} core parity column and a 4^{th} core parity column and all the extension parity columns, namely, a 25^{th} column to a 35^{th} column, are mapped to a 5^{th} bit position and a 6^{th} bit position, namely, two bit positions with lowest energy, in the QAM symbol. In other words, in each QAM symbol, a bit at a 1^{st} bit position is a bit from the 3^{rd} column to first 192 bits in the 8^{th} column, and a bit at a 2^{nd} bit position is a bit from a 193^{rd} bit in the 8^{th} column to the 13^{th} column. In each QAM symbol, a bit at a 3^{rd} bit position is a bit from the 14^{th} column to first 192 bits in the 19^{th} column, and a bit at a 4^{th} bit position is a bit from a 193^{rd} bit in the 19^{th} column to the 24^{th} column. In each QAM symbol, a bit at a 5^{th} bit position is a bit from the 25^{th} column to first 192 bits in the 30^{th} column, and a 6^{th} bit position is a bit from a 193^{rd} bit in the 30^{th} column to bits in the 35^{th} column.

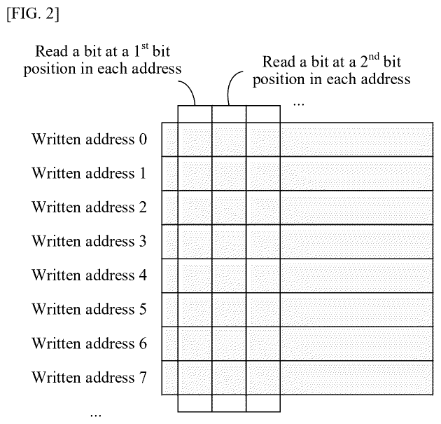

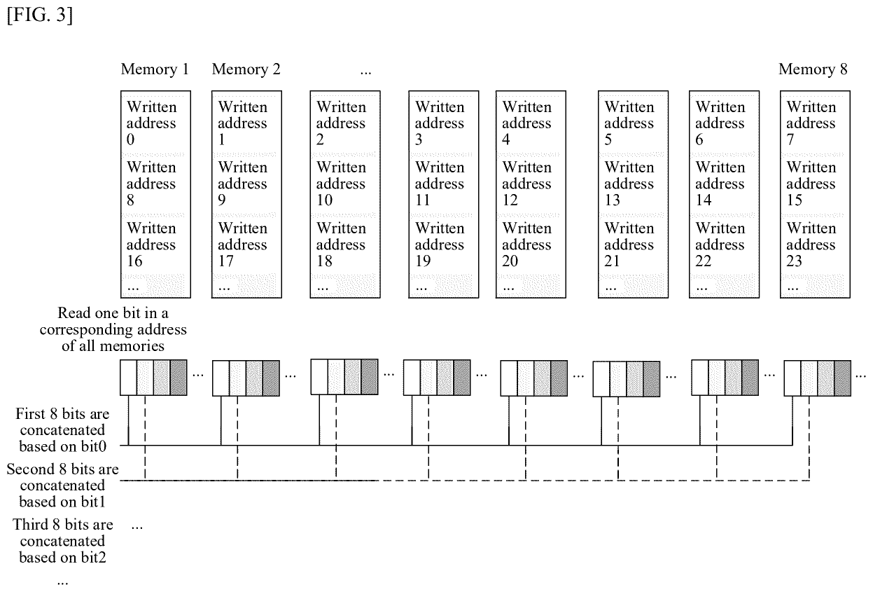

FIG. 2 is a diagram of reading and writing of row-column interleaving. As shown in FIG. 2, when the interleaving is performed at a transmitting end, writing is performed row by row in an order of an address 0, an address 1, an address 2, . . . , and an address 7. Then, reading is performed column by column. Specifically, a bit at a 1^{st} bit position of each address is first read, and then a bit at a 2^{nd} bit position of each address is read. The rest can be deduced by analogy. It can be learned that when the interleaving is performed at the transmitting end, 8-bit writing and 1-bit reading are performed. A reading/writing mode of the row-column interleaving seems simple, but actually no memory can support this operation. When deinterleaving is performed at a receiving end, 8-log-likelihood ratio (LLR) inputting and 1-LLR outputting are performed. This suppresses a deinterleaving speed and affects an overall decoding rate. A throughput bottleneck of a decoder may be transferred from decoding to deinterleaving, especially in an ultra-high throughput scenario. In addition, in a high order modulation scheme, a deinterleaving process is more complex and becomes a system bottleneck. To improve a deinterleaving speed, a large quantity of hardware resources need to be consumed. For example, to support parallel 8-bit writing and 8-bit reading, a bit width of a memory needs to be extended, as shown in FIG. 3.

FIG. 3 is a diagram of implementing row-column interleaving through memory concatenation. For example, eight memories are concatenated, so that 8-bit writing and 8-bit reading can be implemented. However, this manner greatly increases hardware costs. For example, if 24 LLRs need to be read and written in parallel, assuming that each LLR is a quantization bit width of 8 bits, a total bit width of 24×8×8=1536 bits are needed, and hardware costs are very high.

Based on the foregoing technical status, this application provides an interleaving method, a deinterleaving method, and a corresponding communication apparatus in channel coding, to reduce complexity of bit interleaving while ensuring interleaving performance.

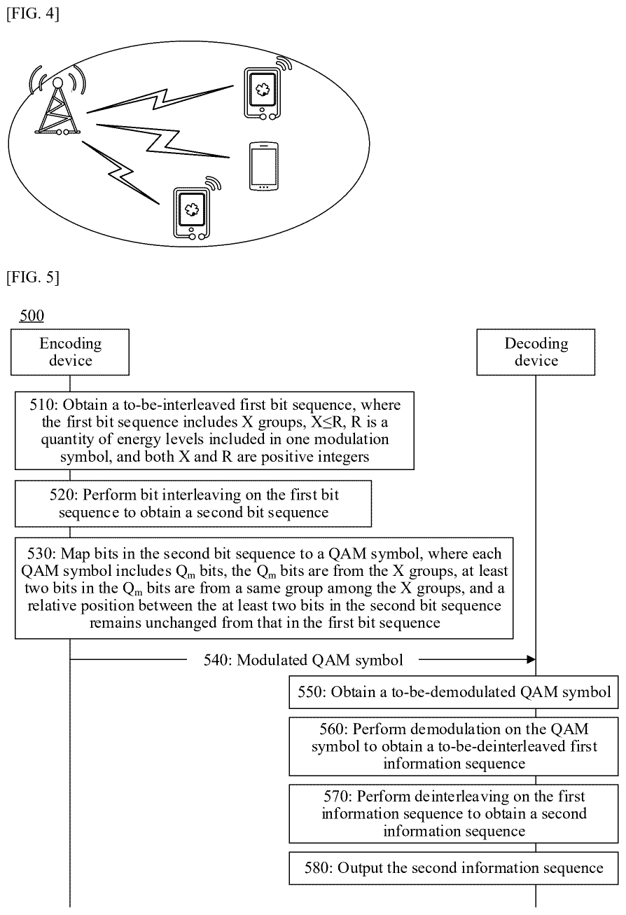

FIG. 4 is a diagram of a system architecture applicable to embodiments of this application. As shown in FIG. 4, the system architecture may include an encoding device and a decoding device. A quantity of encoding devices is not limited to one or more, and a quantity of decoding devices is not limited to one or more. For example, one of the encoding device and the decoding device may be a network device, and the other may be a terminal device.

The terminal device in embodiments of this application includes various communication kits (communication kits, where the communication kit may include, for example, an antenna, a power supply template, a cable, and a wireless fidelity (Wi-Fi) module), a handheld device, or a vehicle-mounted device with a wireless communication function, or another processing device connected to a wireless modem, and may be specifically user equipment (UE), a user, an access terminal, a subscriber unit, a subscriber station, a mobile station, a remote station, a remote terminal, a mobile device, a user terminal, a terminal, a wireless communication device, a user agent, a user apparatus, a wireless modem, a machine type communication device, or another processing device connected to a wireless modem. Alternatively, the terminal device may be a virtual reality (VR) terminal device, an augmented reality (AR) terminal device, a wireless terminal in industrial control, a terminal in self driving, a terminal in remote medical, a terminal in a smart grid a terminal in transportation safety, a terminal in a smart city, a terminal in a smart home, a terminal device in a future communication network, or the like. Certainly, the terminal device in this application may alternatively be a chip, a modem, a system on a chip (SoC), or a communication platform that may include a radio frequency (RF) part or the like, which are mainly responsible for a related communication function in the device.

The network device in embodiments of this application may include but is not limited to a next generation base station (gNB) in a 5^{th} generation (5G) communication system, a base station in a future mobile communication system, an access point (AP), a wireless relay node, a wireless backhaul node, a transmission point (TP) or a transmission reception point (TRP) in a wireless fidelity (Wi-Fi) system, an evolved NodeB (eNB) in a long term evolution (LTE) system, a network device in a non-terrestrial network (NTN) communication system, and the like. The network device may alternatively be one antenna panel or a group of (namely, a plurality of) antenna panels of the base station. In addition, the network device may alternatively be a network node that forms a gNB or a TP, for example, a baseband processing unit (BBU), a central unit (CU), a distributed unit (DU), or a radio unit (RU). Alternatively, the network device may be a device or the like that undertakes a network side function and that is in a device-to-device (D2D) communication system, a machine to machine (M2M) communication system, an internet of things (IoT), an internet of vehicles communication system, or another communication system. This is not limited.

In embodiments of this application, an apparatus configured to implement a function of a terminal may be a terminal, or may be an apparatus, for example, a chip (or a chip system) or a circuit, that can support the terminal in implementing the corresponding function. The apparatus may be mounted in the terminal. In addition, an apparatus configured to implement a function of the network device may be a network device, or may be an apparatus, for example, a chip (or a chip system) or a circuit, that can support the network device in implementing the corresponding function. The apparatus may be mounted in the network device. Optionally, the chip system may include a chip, or may include a chip and another discrete device.

In the system architecture shown in FIG. 4, in uplink communication, the encoding device is a terminal device, and the decoding device is a network device. In downlink communication, the encoding device is a network device, and the decoding device is a terminal device.

FIG. 5 is a schematic flowchart of an interleaving method and a deinterleaving method according to this application. In the method 500, step 510 to step 540 may be performed by an encoding device or an apparatus (for example, a chip, a chip system, or a circuit) used in the encoding device, and step 550 to step 580 may be performed by a decoding device or an apparatus (for example, a chip, a chip system, or a circuit) used in the decoding device. Descriptions are separately provided below by using the encoding device and the decoding device as examples for description.

In addition, the technical solutions in this application may be applied to a QAM modulation scheme, and are also applicable to some other modulation schemes, for example, pulse amplitude modulation (PAM) and phase shift keying (PSK) modulation. The following first describes application of the technical solutions in this application in QAM modulation, and then describes application of the technical solutions in this application in another modulation scheme.

510: The encoding device obtains a to-be-interleaved first bit sequence, where the first bit sequence includes X groups, X is less than or equal to R (X≤R), R is a quantity of energy levels included in one modulation symbol, and both X and R are positive integers.

As described above, in high order modulation, bits included in one modulation symbol have different energy. In QAM modulation, there are two bits having same energy. For example, in QAM64, energy at a 1^{st} bit position and energy at a 2^{nd} bit position are the same, energy at a 3^{rd} bit position and energy at a 4^{th} bit position are the same, and energy at a 5^{th} bit position and energy at a 6^{th} bit position are the same. Therefore, bits included in one modulation symbol in QAM64 correspond to three energy levels. In some other modulation schemes, bits in one modulation symbol each may have different energy. For example, in PAM modulation, bits included in one symbol each have different energy. For another example, in PSK modulation, based on different quantities of PSK modulation constellations, a quantity of bits of one energy level may be two or one.

In this application, bits in the first bit sequence may be divided into X groups, and X may be equal to or less than the quantity R of energy levels included in one modulation symbol. For example, for QAM64, one modulation symbol includes six bits, which are classified into three energy levels, and the bits in the first bit sequence may be divided into three groups or fewer than three groups. In an example, every two bits of a same energy level may be grouped into one group, so that the bits can be divided into three groups. In another example, two bits of a lowest energy level may be grouped into one group, and four bits corresponding to remaining two energy levels are grouped into one group. The bits are divided into two groups in total. For QAM32, one modulation symbol includes five bits. Two bits of a lowest energy level may be grouped into one group, and remaining three bits are grouped into one group. The bits are divided into two groups in total.

The following Example 2 to Example 4 provide some specific methods for performing grouping on the first bit sequence. For details, refer to the following descriptions.

520: The encoding device performs bit interleaving on the first bit sequence to obtain a second bit sequence.

Bit interleaving is performed on the first bit sequence based on the X groups included in the first bit sequence, to obtain the second bit sequence.

530: The encoding device maps bits in the second bit sequence to a QAM symbol, where each QAM symbol includes Qₘ bits, the Qₘ bits are from the X groups, at least two bits in the Qₘ bits are from a same group among the X groups, and a relative position between the at least two bits in the second bit sequence remains unchanged from that in the first bit sequence.

It can be learned from the diagram of row-column interleaving shown in FIG. 2 that, in row-column interleaving, a to-be-interleaved bit sequence is actually divided into Qₘ groups, and each group occupies one bit in any modulation symbol. For example, a length of the to-be-interleaved bit sequence is 16, indexes corresponding to bit positions are 0 to 15 (or 1 to 16, where the following uses the indexes 0 to 15 as an example for description). Assuming that QAM16 is used, Qₘ−4. According to a row-column interleaving rule, the 16 bits are divided into four groups, and each modulation symbol includes one bit from each of the four groups. For example, a modulation symbol 1 includes a bit position 1, a bit position 5, a bit position 9, and a bit position 13. A modulation symbol 2 includes a bit position 2, a bit position 6, a bit position 10, and a bit position 14. A modulation symbol 3 includes a bit position 3, a bit position 7, a bit position 11, and a bit position 15. A modulation symbol 4 includes a bit position 4, a bit position 8, a bit position 12, and a bit position 16.

However, in this embodiment of this application, QAM16 is also used. According to a principle that X≤R, it is assumed that the to-be-interleaved first bit sequence is divided into two groups, that is, X=R=2. Each modulation symbol still includes two 2 bits, but at least two bits in each modulation symbol are from a same group in the two groups. For example, in four bits included in each modulation symbol, two bits are from a first group, and the other two bits are from a second group. For example, a modulation symbol 1 includes a bit position 1, a bit position 2, a bit position 9, and a bit position 10. A modulation symbol 2 includes a bit position 3, a bit position 4, a bit position 11, and a bit position 12. A modulation symbol 3 includes a bit position 5, a bit position 6, a bit position 13, and a bit position 14. A modulation symbol 4 includes a bit position 7, a bit position 8, a bit position 15, and a bit position 16.

It can be learned that the at least two bits in the Qₘ bits included in one modulation symbol are from the same group among the X groups. In addition, the relative position between the at least two bits from the same group in the second bit sequence remains unchanged from that in the first bit sequence.

It should be noted that the relative position between the at least two bits in the first bit sequence or the second bit sequence is the relative position between the at least two bits, instead of respective relative positions of the at least two bits in the first bit sequence or the second bit sequence. The foregoing example is still used for description. For example, two bits corresponding to the bit position 1 and the bit position 2 included in the modulation symbol 1 are from a same group; and in the first bit sequence before the interleaving or the second bit sequence after the interleaving, the bit position 1 is always before the bit position 2, and a relative position between the bits at the two bit positions remains unchanged. Similarly, two bits corresponding to the bit position 9 and the bit position 10 included in the modulation symbol 1 are from a same group; and in the first bit sequence before the interleaving or the second bit sequence after the interleaving, the bit position 9 is always located before the bit position 10, and a relative position remains unchanged.

Actually, that the at least two bits in the Qₘ bits included in one modulation symbol are from the same group among the X groups, and the relative position between the at least two bits in the second bit sequence remains unchanged from that in the first bit sequence means that an order of the at least two bits is not scrambled during the interleaving. In other words, the at least two bits are bundled together as a whole in an interleaving process, and the whole remains unchanged in the second bit sequence after the interleaving from that in the first bit sequence before the interleaving. In other words, interleaving is not performed between the at least two bits. In this way, hardware complexity of the bit interleaving can be reduced.

540: The encoding device outputs a QAM symbol.

After completing the bit interleaving and modulation, the encoding device outputs the modulated QAM symbol.

550: The decoding device obtains a to-be-demodulated QAM symbol.

560: The decoding device performs demodulation on the QAM symbol to obtain a first information sequence.

The first information sequence is a sequence of LLR information obtained through demodulation. Each piece of LLR information represents a probability that a bit at a corresponding bit position is 0 or 1.

570: The decoding device performs deinterleaving on the first information sequence to obtain a second information sequence.

The second information sequence is a sequence of LLR information.

580: The decoding device outputs the second information sequence.

Step 540 to step 580 describe processes of the demodulation and the deinterleaving. In addition, the decoding device may further determine an information bit based on the second information sequence, to complete decoding.

LLR information in the second information sequence includes X groups, each QAM symbol includes Qₘ pieces of LLR information, the Qₘ pieces of LLR information are from the X groups of the second information sequence, at least two pieces of LLR information in the Qₘ pieces of LLR information are from a same group among the X groups, a relative position between the at least two pieces of LLR information in the second information sequence remains unchanged from that in the first information sequence, X is less than or equal to R (X≤R), R is a quantity of energy levels included in one modulation symbol, and both X and R are positive integers.

In step 550 to step 580, the demodulation and the deinterleaving performed by the decoding device are respectively inverse processing of the modulation and the interleaving performed by the encoding device, and a principle is the same as that at an encoding device end. At a decoding device end, the LLR information obtained by demodulating the QAM symbol corresponds to the bits at the encoding device end, and specifically includes a systematic bit and a parity bit. A person skilled in the art may learn, based on descriptions of the encoding device side, how to perform demodulation and deinterleaving on the decoding device side.

It can be learned from the foregoing descriptions of the technical solutions that, in the technical solutions in this application, performing grouping on the to-be-interleaved bit sequence based on the quantity of energy levels included in the modulation symbol and performing bit interleaving based on the groups can reduce complexity of the bit interleaving. In addition, it can be learned from performance simulation that, in the interleaving method in this application, performance of the bit interleaving can be ensured to basically remain unchanged. In other words, interleaving complexity is reduced without deterioration of the performance of the bit interleaving.

The following provides several specific examples of applying the technical solutions provided in this application in QAM modulation.

In the following examples, it is assumed that an I signal and a Q signal in the QAM symbol each include q bits. Therefore, each QAM symbol includes 2q bits, where Qₘ=2q, and q is a positive integer. Every two bits in the 2q bits are to be mapped to two bit positions with same energy in the QAM symbol.

### Example 1

Two bits that are in the to-be-interleaved first bit sequence and that are to be mapped to a same energy level are bundled together for bit interleaving. The first bit sequence is divided into X=Qₘ/2 groups.

Specifically, after a modulation order is determined, a quantity Qₘ of bits that can be included in one modulation symbol is known, and every two bit positions in one QAM symbol have equal energy. Therefore, every two bits in Qₘ bits that belong to one modulation symbol in the first bit sequence are grouped into one subgroup. In this way, Qₘ bits included in each modulation symbol are to be divided into Qₘ/2 subgroups. Subgroups of a same index of all modulation symbols form one group, so that X=Qₘ/2 groups are obtained. Therefore, in Example 1, the first bit sequence is divided into X groups, where X=Qₘ/2.

For example, a bit interleaving algorithm in Example 1 may be shown as follows:

```
for j = 0 to E/Qₘ − 1
for i = 0 to Qₘ/2 − 1
    f_{i·2+j·Q}_{ₘ} = e_{i·2·E/Q}_{ₘ}_{+j·2}
    ${f}_{i \cdot 2 + 1 + j \cdot {Q}_{m}} = {e}_{i \cdot 2 \cdot \frac{E}{{Q}_{m}} + j \cdot 2 + 1}$
end for
end for
```

In the algorithm, E represents a length of the first bit sequence, Qₘ represents a quantity of bits included in each modulation symbol, e represents the first bit sequence before the interleaving, and f represents the second bit sequence obtained through interleaving. j represents an index of the QAM symbol, and i represents a position index of a bit included in each QAM symbol. For the first bit sequence whose length is E, a quantity of QAM symbols is E/Qₘ. Therefore, a value of j ranges from 0 to E/Qₘ−1. If a quantity of bits included in one QAM symbol is Qₘ, a value of i ranges from 0 to Qₘ−1.

It can be learned that, in Example 1, in a bit interleaving process, every two adjacent bits in the first bit sequence are bundled together. For example, a value of j is given, two bit positions whose position indexes are i·2·E/Qₘ+j·2 and

$$i \cdot 2 \cdot \frac{E}{{Q}_{m}} + j \cdot 2 + 1$$

in the sequence e are adjacent. After interleaving is performed on bits at the two bit positions, the bits are respectively located at two adjacent bit positions whose position indexes are i·2+j·Qₘ and i·2+1+j·Qₘ in the sequence f, and a relative position between the bits at the two bit positions in the sequence f remains unchanged from that in the sequence e.

In comparison with the interleaving method in conventional technologies, in the bit interleaving method provided in Example 1, if a quantity of bits included in one QAM symbol is Qₘ, in QAM modulation, Qₘ bits correspond to Qₘ/2 energy levels, and each energy level corresponds to two bits. Two bits that are in the first bit sequence and that are mapped to each of the Qₘ/2 energy levels are bundled together. Therefore, the first bit sequence is divided into X=Qₘ/2 groups. In comparison with row-column interleaving in which a to-be-interleaved bit sequence is divided into Qₘ groups for even interleaving, in a grouping manner of the first bit sequence in Example 1, a quantity of groups into which the first bit sequence is divided is reduced by half.

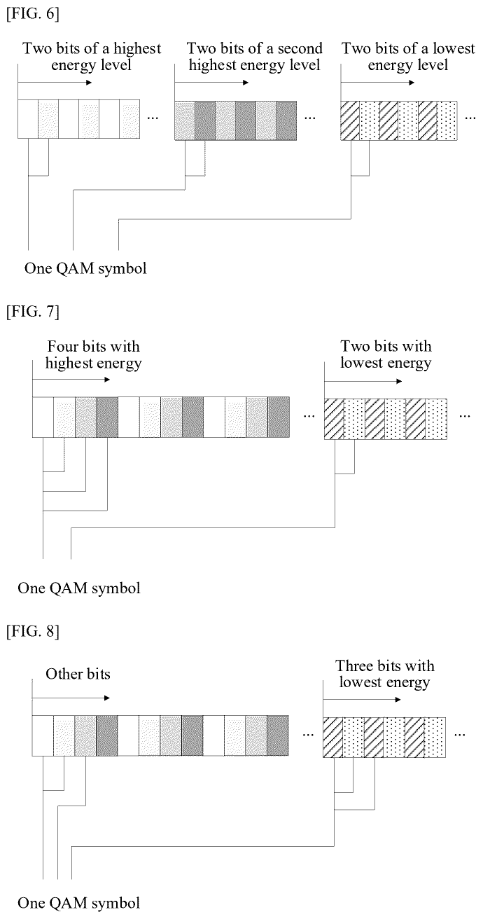

FIG. 6 is a diagram of the bit interleaving process in Example 1 according to this application. Assuming that 24 LLRs are to be read and written, a quantization bit width of each LLR is 8 bits, and a bit interleaving scheme in Example 1 is used, a needed systematic bit width is 24×4×8=768 bits. In comparison with the row-column interleaving shown in FIG. 3, the systematic bit width is reduced by half.

### Example 2

Bit interleaving is performed by bundling together two bits that are in the to-be-interleaved first bit sequence and that are to be mapped to a lowest energy level and bundling together remaining bits. The first bit sequence is divided into two groups, that is, X=2.

Specifically, after a modulation order is determined, a quantity Qₘ of bits that can be included in one modulation symbol is known, and every two bit positions in one QAM symbol have equal energy. Therefore, two bits that are in the first bit sequence and that correspond to lowest energy in Qₘ bits that belong to one modulation symbol are grouped into one subgroup, and remaining Qₘ−2 bits are grouped into one subgroup. In this way, Qₘ bits included in each modulation symbol are to be divided into two subgroups. Subgroups in which two bits corresponding to lowest energy of all the modulation symbols are located are considered as one group, the other subgroups of all the modulation symbols are considered as one group, so that X=2 subgroups are obtained. Therefore, in Example 2, the first bit sequence is divided into X groups, where X=2.

For example, a bit interleaving algorithm in Example 2 may be shown as follows:

```
for j=0 to E/Qₘ−1
for i=0 to Qₘ − 2
  f_{i+j·Q}_{ₘ} =e_{i+j(Q}_{ₘ}₋₂₎
end for
for i=Qₘ − 2 to Qₘ − 1
  f_{i+j·Q}_{ₘ} =e_{i+E/Q}_{ₘ}_{(Q}_{ₘ}_{-2)+j·2}
end for
end for
```

In the algorithm, for a meaning represented by each letter, refer to descriptions in Example 1.

In Example 2, the bit interleaving is performed by bundling together the two bits corresponding to the lowest energy level in the to-be-interleaved sequence and bundling together the other remaining bits.

If a quantity of bits included in one QAM symbol is Qₘ, and the Qₘ bits correspond to Qₘ/2 energy levels, each energy level corresponds to two bits. The Qₘ/2 energy levels include a lowest energy level. Two bits of the lowest energy level in the first bit sequence are grouped into one group, and the other bits are grouped into one group. Therefore, in Example 2, the first bit sequence is divided into two groups, and X=2.

FIG. 7 is a diagram of a bit interleaving process in Example 2 according to this application. Assuming that 24 LLRs are to be read and written, a quantization bit width of each LLR is 8 bits, and Example 2 is used, a needed systematic bit width is 24×2×8=384 bits. In comparison with the row-column interleaving shown in FIG. 3, the systematic bit width may be reduced. In addition, in comparison with the method in Example 1, the systematic bit width is further reduced.

### Example 3

Bit interleaving is performed by bundling together first A bits in ascending order of energy in the to-be-interleaved first bit sequence and bundling together the other bits. The first bit sequence is divided into two groups, where X=2.

Specifically, after a modulation order is determined, a quantity Qₘ of bits that can be included in one modulation symbol is known. First, A is calculated, first A bits in ascending order of energy in Qₘ bits that belong to one modulation symbol in the first bit sequence are grouped into one subgroup, and remaining Qₘ−A bits in the modulation symbol are grouped into one subgroup, so that Qₘ bits included in each modulation symbol are divided into two subgroups. Subgroups in which the A bits of all the modulation symbols are located are one group, and the other subgroups of all the modulation symbols are one group, so that X=2 groups are obtained. Therefore, in Example 3, the first bit sequence is divided into X groups, where X=2.

In an example, a value of A may be selected based on a code rate.

For example, A is determined according to the following formula (1):

$$A = round ( ( 1 - code rate ) \cdot {Q}_{m} ) \qquad ( 1 )$$

round represents a round function. Optionally, round may alternatively be replaced with a ceil function or a floor function. The ceil function is a round-up function, and the floor function is a round-down function.

FIG. 8 is a diagram of a bit interleaving process in Example 3 according to this application. As shown in FIG. 8, QAM64 is used as an example, and Qₘ=6. Assuming that a code rate is ½ and an information bit length K=8448, there are 22 information columns, and a total quantity of to-be-sent columns is 44. 20 information columns are to be sent. Plus four core parity columns, there are 24 columns. Therefore, there are 20 extension parity columns. Substituted into the foregoing formula (1), A=round (1−½)·6=3. In the first bit sequence, first three bits in ascending order of energy are bundled together as one subgroup, and the other bits are bundled together as one subgroup. In the example, first three bits in ascending order of energy are one subgroup, and remaining Qₘ−A−6−3=3 bits are one subgroup. In the first bit sequence, a subgroup in which the three bits with relatively low energy are located is one group, and a remaining subgroup is one group, so that the first bit sequence is divided into two groups.

For example, a bit interleaving algorithm in Example 3 may be shown as follows:

```
for j=0 to E/Qₘ−1
for i=0 to Qₘ − A
  f_{i+j·Q}_{ₘ} =e_{i+j(Q}_{ₘ}_{-A)}
end for
for i=Qₘ − A to Qₘ − 1
  f_{i+j·Q}_{ₘ} =e_{i+E/Q}_{ₘ}_{(Q}_{ₘ}_{-A)+j·A}
end for
end for
```

In Example 3, assuming that 24 LLRs are to be read and written and a quantization bit width of each LLR is 8 bits, a needed systematic bit width is 24×2×8=384 bits. In comparison with the row-column interleaving shown in FIG. 3, the systematic bit width may be reduced. In comparison with Example 2, interleaving is more flexible, and interleaving performance is better.

### Example 4

Bit interleaving is performed by bundling together first A bits in ascending order of energy in the to-be-interleaved first bit sequence and bundling together the other bits. The first bit sequence is divided into two groups, where X=2.

In Example 4, a process of dividing the first bit sequence into the X groups is the same as that in Example 3. A difference is that a value of A may be selected based on a sending ratio of a core matrix and an extension matrix.

For example, A is determined according to the following formula (2):

$$A = round ( quantity of columns of the extension matrix / ( quantity of to - be - sent columns of the core matrix + quantity of to - be - sent columns of the extension matrix ) \cdot {Q}_{m} ) \qquad ( 2 )$$

In LDPC, a core matrix includes columns corresponding to systematic bits and core parity bits, and an extension matrix includes columns corresponding to raptor codes (raptor codes). In 5G LDPC, a greatest difference between an extension matrix and a core matrix is that a column degree of an extension parity bit corresponding to the extension matrix is 1, in other words, a column corresponding to a base graph has only one parity node.

round represents a round function. Optionally, round may alternatively be replaced with a ceil function or a floor function.

A bit interleaving algorithm in Example 4 is the same as that in Example 3. A difference is that a meaning represented by A is different. If the solution of Example 4 is used, similarly, if a quantization bit width of each LLR is 8 bits, a needed systematic bit width is 24×2×8=384 bits. It can be learned that, in comparison with the row-column interleaving, the systematic bit width may be reduced, and interleaving performance is better.

It should be noted that, in Example 3 and Example 4, the bits in the first bit sequence are divided into X groups, where X=2. That is, the bits are divided into two groups. A bits in Qₘ bits included in each modulation symbol are from a first group, and remaining (Qₘ−A) bits are from a second group. If A=0 in the foregoing formula (1) or formula (2), it may be found that the first bit sequence has only one group. This means that bit interleaving is not performed on the first bit sequence. Therefore, in Example 3 or Example 4, before the bit interleaving is performed, A is first calculated according to the formula (1) or the formula (2), and the bit interleaving is performed when A is greater than or equal to 1 (or not equal to 0). If A is calculated to be 0, it may be further determined that the bit interleaving is not performed on the first bit sequence.

For modulation schemes of QAM32 and QAM128, the foregoing Example 2, Example 3, and Example 4 are also completely applicable and compatible.

The foregoing provides application examples of the technical solutions in this application in the QAM modulation. The following describes application of the technical solutions in another modulation scheme.

The PAM modulation may be understood as separate QAM modulation. For example, joint modulation of two pieces of PAM8 on the I signal and the Q signal is one piece of QAM64 modulation. In an implementation, A may be calculated according to the method in Example 3 or Example 4, to determine the grouping manner of the first bit sequence, and then the bit interleaving and mapping are performed based on the X groups. In another implementation, the bits in the first bit sequence may alternatively be divided into two groups according to the method in Example 2. One group includes a bit corresponding to lowest energy, and the other group includes a bit corresponding to other energy. It should be noted that, a difference between PAM and QAM is that in PAM, each symbol has only one bit with lowest energy, while in QAM, each symbol has two bits with lowest energy. Therefore, if the grouping manner in Example 2 is applied to PAM, the first bit sequence is divided into two groups. One group includes one bit with lowest energy, and the other group includes remaining (Qₘ−1) bits with other energy in a PAM symbol.

For PSK modulation, in an implementation, A is calculated according to the method in Example 3 or Example 4, to determine the grouping manner of the first bit sequence, and then the bit interleaving and mapping are performed. In another implementation, the first bit sequence may be divided into two groups according to the manner in Example 2. However, in PSK modulation, because quantities of PSK modulation constellations are different, there may be one or two bits with lowest energy. Therefore, a possible grouping manner is as follows: One group includes one bit with the lowest energy, and the other group includes remaining (Qₘ−1) bits except the one bit with the lowest energy. Another possible grouping manner is as follows: One group includes two bits with the lowest energy, and the other group includes remaining (Qₘ−2) bits.

The foregoing describes in detail application of the technical solutions provided in this application in different high order modulation. In comparison with “even interleaving” in the row-column interleaving in the conventional technologies, the bit interleaving method in embodiments of this application is no longer even interleaving, and an order of some bits in the to-be-interleaved first bit sequence is not scrambled in the interleaving process. Specifically, the bit interleaving method may be implemented by using a grouping manner of the bits in the first bit sequence provided in embodiments of this application, so that hardware complexity of the interleaving can be reduced.

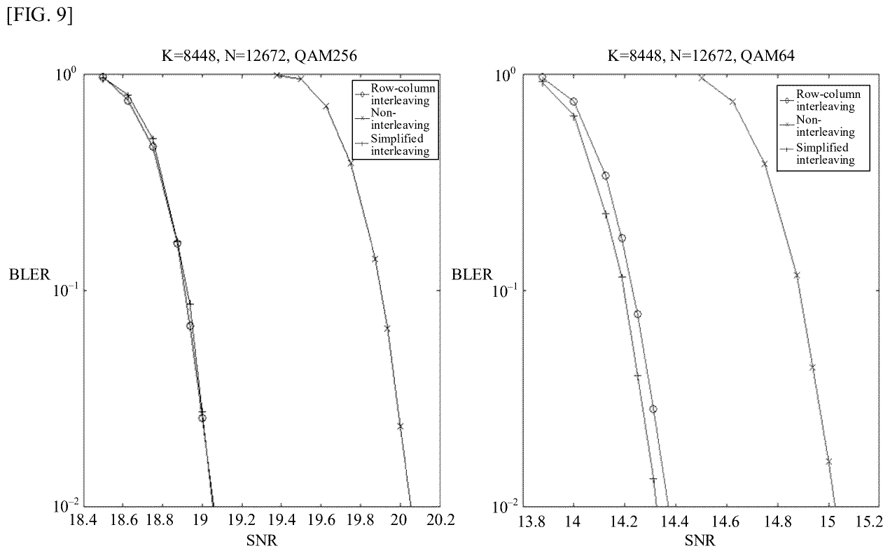

FIG. 9 is a simulation comparison diagram of performance of an interleaving method provided in this application and performance of an interleaving method in the conventional technologies. FIG. 9 shows performance curves of “non-interleaving”, a “row-column interleaving” scheme in the conventional technologies, and an interleaving scheme (for example, “simplified interleaving” in the legend) provided in this application. In simulation, QAM64 and QAM256 are used as an example, and a to-be-interleaved bit sequence is divided into two groups. For QAM64, one group includes four bits, and the other group includes two bits. For QAM256, one group includes six bits, and the other group includes two bits. It can be learned that, in comparison with row-column interleaving, in the simplified interleaving scheme of this application, a block error rate (block error rate, BLER) basically remains unchanged with the same signal-to-noise ratio (signal-to-noise ratio, SNR). However, in comparison with the row-column interleaving, the simplified interleaving method provided in this application has lower hardware implementation complexity.

The foregoing describes in detail the interleaving method or the deinterleaving method provided in this application. The following describes a communication apparatus provided in this application.

Refer to FIG. 10. This application provides a communication apparatus 1000.

The communication apparatus 1000 may be an encoding device, or may be an apparatus, for example, a chip, a chip system, or a circuit, that is used in the encoding device and that can implement a corresponding function of the encoding device in the method embodiment of this application. Alternatively, the communication apparatus 1000 may be a decoding device, or may be an apparatus, for example, a chip, a chip system, or a circuit, that is used in the decoding device and that can implement a corresponding function of the decoding device in the method embodiment of this application.

Optionally, the communication apparatus 1000 includes a processing module 1001. The processing module may be a processor, a processing board, a processing unit, a processing apparatus, or the like. When the communication apparatus 1000 is an encoding device or an apparatus used in the encoding device, the processing module 1001 is configured to: perform bit interleaving on a to-be-interleaved first bit sequence, to obtain a second bit sequence, and map bits in the second bit sequence to a QAM symbol. For a specific process, refer to detailed descriptions of the interleaving process in the method embodiment. When the communication apparatus 1000 is a decoding device or an apparatus used in the decoding device, the processing module 1001 is configured to: perform demodulation on a to-be-demodulated QAM symbol to obtain a first information sequence, and perform deinterleaving on the first information sequence to obtain a second information sequence. For a specific process, refer to descriptions of the deinterleaving process in the method embodiment.

Optionally, the communication apparatus 1000 further includes a communication module 1002. The communication module may also be referred to as a transceiver module, a transceiver, a transceiver machine, a transceiver apparatus, or the like, and is configured to perform a receiving (or input) and/or sending (or output) operation. For example, when the communication apparatus 1000 is an encoding device or an apparatus used in the encoding device, the communication module 1002 may be configured to: obtain the to-be-interleaved first bit sequence, output a modulated QAM symbol, and the like. When the communication apparatus 1000 is a decoding device or an apparatus used in the decoding device, the communication module 1002 may be configured to: obtain the to-be-demodulated QAM symbol, output the second information sequence, and the like.

In addition, it should be noted that the communication module and/or the processing module may be implemented by using a virtual module. For example, the processing module may be implemented by using a software functional unit or a virtual apparatus, and the communication module may be implemented by using a software function or a virtual apparatus. Alternatively, the processing module or the communication module may be implemented by using a physical apparatus. For example, if the apparatus is implemented by using a chip/circuit (for example, an integrated circuit or a logic circuit), the communication module may be an input/output circuit and/or a communication interface, and performs an input operation (corresponding to the foregoing receiving operation) and an output operation (corresponding to the foregoing sending operation); and the processing module is an integrated processor, a microprocessor, or a circuit (for example, an integrated circuit or a logic circuit).

In this application, division of the modules is an example, and is merely logical function division. During actual implementation, there may be another division manner. In addition, functional modules in examples of this application may be integrated into one processor, each of the modules may exist alone physically, or two or more modules may be integrated into one module. The integrated module may be implemented in a form of hardware, or may be implemented in a form of a software functional module.

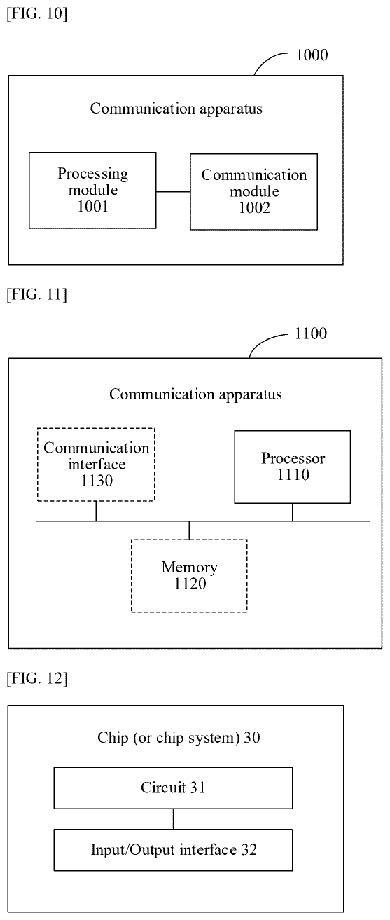

As shown in FIG. 11, this application further provides a communication apparatus 1100. The communication apparatus 1100 includes at least one processor 1110, and implements a function of the encoding device or the decoding device described in the foregoing method embodiment.

Optionally, the processor 1110 is coupled to a memory. The memory may be located in the communication apparatus. Alternatively, the memory may be integrated with the processor. Alternatively, the memory may be located outside the communication apparatus. The communication apparatus 1100 may further include at least one memory 1120. The memory 1120 stores a computer program, instructions, data, or the like necessary for implementing any one of the foregoing method embodiments. The processor 1110 may execute the computer program, the instructions, the data, or the like stored in the memory 1120, to complete the interleaving method or the deinterleaving method in any one of the foregoing embodiments.

Optionally, the communication apparatus 1100 may further include a communication interface 1130, and the communication apparatus 1100 may exchange information with another device through the communication interface 1130. For example, the communication interface 1130 may be a transceiver, a circuit, a bus, a module, a pin, or an interface of another type.

The coupling in this application is an indirect coupling or a communication connection between apparatuses, units, or modules, may be in an electrical form, a mechanical form, or another form, and is used for information exchange between the apparatuses, the units, or the modules. The processor 1110 may operate cooperatively with the memory 1120 and the communication interface 1130. A specific connection medium between the processor 1110, the memory 1120, and the communication interface 1130 is not limited in this application.

As shown in FIG. 12, this application further provides a chip (or a chip system). The chip (or the chip system) 30 may include a circuit 31 and an input/input interface 32. The circuit 31 may be a logic circuit, an integrated circuit, or the like. The input/output interface 32 may also be an input/output circuit, or an interface circuit, and may input information (or referred to as receiving information) and output information (or referred to as sending information). Optionally, the chip system may include a chip, or may include a chip and another discrete device. The chip 30 may be configured to perform the method performed by the encoding device or the decoding device in embodiments of this application.

In addition, this application further provides a computer-readable storage medium. The computer-readable storage medium stores computer instructions. When the computer instructions are run on a computer, an operation and/or processing performed by the encoding device or the decoding device in the method embodiments of this application are/is performed.

This application further provides a computer program product. The computer program product includes computer program code or instructions. When the computer program code or the instructions are run on a computer, an operation and/or processing performed by the encoding device or the decoding device in the method embodiments of this application are/is performed.

In addition, this application further provides a chip. The chip includes a processor. A memory configured to store a computer program is disposed independent of the chip. The processor is configured to execute the computer program stored in the memory, so that an operation and/or processing performed by the encoding device or the decoding device in any method embodiment are/is performed.

Further, the chip may include a communication interface. The communication interface may be an input/output interface, an interface circuit, or the like. Further, the chip may include the memory.

This application provides a communication system, including the encoding device and the decoding device in the foregoing method embodiment.

In this application, the processor may be a general-purpose processor, a digital signal processor, an application-specific integrated circuit, a field programmable gate array, another programmable logic device, a discrete gate, a transistor logic device, or a discrete hardware component, and can implement or execute the methods, steps, and logical block diagrams disclosed in this application. The general-purpose processor may be a microprocessor, any conventional processor, or the like. The steps of the methods disclosed with reference to this application may be directly implemented by a hardware processor, or may be implemented by a combination of hardware and a software module in a processor.

The memory may be a nonvolatile memory, for example, a hard disk drive (HDD) or a solid-state drive (SSD), or may be a volatile memory (volatile memory), for example, a random access memory (RAM). The memory is any other medium that can carry or store expected program code in a form of an instruction or a data structure and that can be accessed by a computer, but is not limited thereto. Alternatively, the memory in this application may be a circuit or any other apparatus that can implement a storage function, and is configured to store program instructions and/or data.

All or some of the technical solutions provided in this application may be implemented by using software, hardware, firmware, or any combination thereof. When software is used to implement the technical solutions, all or some of the technical solutions may be implemented in a form of a computer program product. The computer program product includes one or more computer instructions. When the computer program instructions are loaded and executed on the computer, the procedure or the function according to this application are all or partially generated. The computer may be a general-purpose computer, a dedicated computer, a computer network, a terminal device, an access network device, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, into which one or more usable media are integrated. The usable medium may be a magnetic medium (for example, a floppy disk, a hard disk drive, or a magnetic tape), an optical medium (for example, a digital video disc (DVD)), a semiconductor medium, or the like.

In this application, on the premise that there is no logic contradiction, the examples can be referenced from each other. For example, methods and/or terms in the method embodiments can be referenced from each other, functions and/or terms in the apparatus embodiments can be referenced from each other, and functions and/or terms in the apparatus examples and the method examples can be referenced from each other.

A person of ordinary skill in the art may be aware that, in combination with the examples described in embodiments disclosed in this specification, units and algorithm steps can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for ease and brevity of description, for a detailed working process of the foregoing system, apparatus, and unit, refer to a corresponding process in the foregoing method embodiment.

In the several embodiments provided in this application, it should be understood that the disclosed system, apparatus, and method may be implemented in another manner. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions in this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the method described in embodiments of this application. The foregoing storage medium includes any medium that can store program code, for example, a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An interleaving method, comprising:
obtaining a to-be-interleaved first bit sequence, wherein the first bit sequence comprises X groups, X is less than or equal to R, R is a quantity of energy levels comprised in one modulation symbol, and both X and R are positive integers;
performing bit interleaving on the first bit sequence to obtain a second bit sequence;
mapping bits in the second bit sequence to a quadrature amplitude modulation (QAM) symbol, wherein each QAM symbol comprises Qₘ bits, the Qₘ bits are from the X groups, at least two bits in the Qₘ bits are from a same group among the X groups, and a relative position between the at least two bits in the second bit sequence remains unchanged from that in the first bit sequence; and
outputting a modulated QAM symbol.

2. The method according to claim 1, wherein that the at least two bits in the Qₘ bits are from the same group among the X groups comprises:
two bits in the Qₘ bits are from a same group among the X groups, and the two bits correspond to two bit positions of a same energy level in the QAM symbol.

3. The method according to claim 1, wherein X=2, and that the at least two bits in the Qₘ bits are from the same group among the X groups comprises:
two bits in the Qₘ bits are from a first group among the X groups, remaining Qₘ−2 bits in the Qₘ bits are from a second group among the X groups, and the two bits in the first group correspond to two bit positions of a lowest energy level in the QAM symbol.

4. The method according to claim 1, wherein X=2, and that the at least two bits in the Qₘ bits are from the same group among the X groups comprises:
A bits in the Qₘ bits are from a first group among the X groups, remaining Qₘ−A bits in the Qₘ bits are from a second group among the X groups, and the A bits in the first group correspond to first A bit positions in ascending order of energy in the QAM symbol.

5. The method according to claim 4, wherein before the performing interleaving on the first bit sequence to obtain the second bit sequence, the method further comprises:
determining A; and
the performing interleaving on the first bit sequence to obtain the second bit sequence comprises:
when A is greater than or equal to 1, performing the bit interleaving on the first bit sequence to obtain the second bit sequence.

6. The method according to claim 4 wherein the A is determined based on a code rate.

7. The method according to claim 4, wherein the A is determined according to the following formula:
A=round((1−code rate)×Qₘ), wherein round represents a round function.

8. The method according to claim 4, wherein the A is determined based on a sending ratio of a core matrix and an extension matrix.

9. The method according to claim 8, wherein the A is determined according to the following formula:
A=round (quantity of columns of the extension matrix/(quantity of to-be-sent columns of the core matrix+quantity of to-be-sent columns of the extension matrix)×Qₘ), wherein round represents the round function.

10. A deinterleaving method, comprising:
obtaining a to-be-demodulated QAM symbol;
performing demodulation on the QAM symbol to obtain a first information sequence;
performing deinterleaving on the first information sequence to obtain a second information sequence, wherein log-likelihood ratio LLR information in the second information sequence comprises X groups, each QAM symbol comprises Qₘ pieces of LLR information, the Qₘ pieces of LLR information are from the X groups of the second information sequence, at least two pieces of LLR information in the Qₘ pieces of LLR information are from a same group among the X groups, a relative position between the at least two pieces of LLR information in the second information sequence remains unchanged from that in the first information sequence, X is less than or equal to R, R is a quantity of energy levels comprised in one modulation symbol, and both X and R are positive integers; and
outputting the second information sequence.

11. The method according to claim 10, wherein that the at least two pieces of LLR information in the Qₘ pieces of LLR information are from the same group among the X groups comprises:
two pieces of LLR information in the Qₘ pieces of LLR information are from a same group among the X groups, and the two pieces of LLR information correspond to two bit positions of a same energy level in the QAM symbol.

12. The method according to claim 10, wherein X=2, and that the at least two pieces of LLR information in the Qₘ pieces of LLR information are from the same group among the X groups comprises:
two pieces of LLR information in the Qₘ pieces of LLR information are from a first group among the X groups, remaining Qₘ−2 pieces of LLR information in the Qₘ pieces of LLR information are from a second group among the X groups, and the two pieces of LLR information in the first group correspond to two bit positions of a lowest energy level in the QAM symbol.

13. The method according to claim 10, wherein X=2, and that the at least two pieces of LLR information in the Qₘ pieces of LLR information are from the same group among the X groups comprises:
A pieces of LLR information in the Qₘ pieces of LLR information are from a first group among the X groups, remaining Qₘ−A pieces of LLR information in the Qₘ pieces of LLR information are from a second group among the X groups, and the A pieces of LLR information in the first group correspond to first A bit positions in ascending order of energy in the QAM symbol.

14. The method according to claim 13, wherein before the performing [claim 14] deinterleaving on the first information sequence to obtain the second information sequence, the method further comprises:
determining A; and
the performing deinterleaving on the first information sequence to obtain the second information sequence comprises:
when A is greater than or equal to 1, performing deinterleaving on the first information sequence to obtain the second information sequence.

15. The method according to claim 13, wherein A is determined based on a code rate.

16. The method according to claim 13, wherein the A is determined according to the following formula:
A=round((1−code rate)×Qₘ), wherein round represents a round function.

17. The method according to claim 13, wherein the A is determined based on a sending ratio of a core matrix and an extension matrix.

18. The method according to claim 17, wherein the A is determined according to the following formula:
A=round (quantity of columns of the extension matrix/(quantity of to-be-sent columns of the core matrix+quantity of to-be-sent columns of the extension matrix)× Qₘ), wherein round represents a round function.

19. A communication apparatus, comprising a processor, the processor is configured to, when executing the programming instructions, enable the communication apparatus to:
obtain a to-be-interleaved first bit sequence, wherein the first bit sequence comprises X groups, X is less than or equal to R, R is a quantity of energy levels comprised in one modulation symbol, and both X and R are positive integers;
perform bit interleaving on the first bit sequence to obtain a second bit sequence;
map bits in the second bit sequence to a quadrature amplitude modulation (QAM) symbol, wherein each QAM symbol comprises Qₘ bits, the Qₘ bits are from the X groups, at least two bits in the Qₘ bits are from a same group among the X groups, and a relative position between the at least two bits in the second bit sequence remains unchanged from that in the first bit sequence; and
output a modulated QAM symbol.

20. The communication apparatus according to claim 19, wherein that the at least two bits in the Qₘ bits are from the same group among the X groups comprises:
two bits in the Qₘ bits are from a same group among the X groups, and the two bits correspond to two bit positions of a same energy level in the QAM symbol.
